(19) United States
(12) Patent Application Publication
(10) Pub. No.: US 2006/0045202 A1
(43) Pub. Date: Mar. 2, 2006

(54) Matching I and Q portions of a device

(76) Inventors: Aslam Rafi, Austin, TX (US); Donald A. Kerth, Austin, TX (US)

Correspondence Address: TROP PRUNER & HU, PC, 8554 KATY FREEWAY, SUITE 100, HOUSTON, TX, 77024, US

(21) Appl. No.: 10/930,709

(22) Filed: Aug. 31, 2004

(51) Int. Cl. H04L 27/18

(52) U.S. Cl. 375/279

(57) ABSTRACT

In one embodiment, the present invention includes a frequency divider that has an I channel to provide an I channel phase; and a Q channel to provide a Q channel phase, in which the I and the Q channels are mirrored with respect to an axis therebetween. The axis may also be substantially coincident with a center axis of a device incorporating the frequency divider, such as a transceiver.

### FIELD OF THE INVENTION

The present invention relates to an integrated circuit (IC) and more particularly to an integrated circuit for use in radio frequency (RF) communications.

### BACKGROUND

In typical RF communication systems, receive and transmit functions may be handled by a single IC, commonly referred to as a transceiver. Such a transceiver performs both receive and transmit functions, and incorporates devices to handle both functions. In a receiver portion of a transceiver, an RF signal input into the receiver is mixed at a mixer with a local oscillator (LO) frequency to obtain an intermediate frequency (IF) signal for use in further processing.

Typically, the mixer receives the LO frequency via one of a number of different sources, such as a crystal oscillator, a voltage controlled oscillator (VCO), a phase locked loop (PLL) and the like. Often, a generated frequency is passed through a frequency divider before it is sent to the mixer. In typical RF systems, a quadrature mixer is present having I (in-phase) and Q (quadrature-phase) channels. Thus, a frequency divider provides an I channel phase output and a Q channel phase output to the quadrature mixer.

In conventional ICs incorporating such a frequency divider, the placement of the frequency divider is dictated by placement of other components, such that the I and Q channels are located where suitable real estate exists on a substrate, and without regard to the desired operation of the frequency divider. Accordingly, the outputs from the frequency divider are often unmatched. As a result, the drops in the power supply rails between corresponding devices in the I and Q sections of the frequency divider are not the same and there is image rejection degradation. Furthermore, a clock frequency (e.g., the generated frequency) input to the frequency divider is provided via signal lines to the I and Q channels that are unmatched from a resistance point of view leading to phase error between the I and Q channels, as differing lengths of signal traces lead to the channels.

As a result, the routing of quadrature LO signals to the quadrature mixer from the frequency divider are not matched. Because of such imperfect matching, problems may exist, including image rejection degradation. Accordingly, a need exists to provide a frequency divider that provides more closely matched outputs to a mixer (e.g., a quadrature mixer) or other device.

### SUMMARY OF THE INVENTION

Embodiments of the present invention may be used to provide closely matched outputs from a frequency divider to a mixer or other such device, thus improving image rejection performance. Accordingly, in one aspect, the present invention includes a frequency divider having an I channel to provide an I channel phase and a Q channel to provide a Q channel phase, where the I and Q channels are mirrored with respect to an axis therebetween. Furthermore, the I and Q channels may be at least substantially symmetric with respect to the axis. The axis may correspond to a center axis of a substrate on which the frequency divider is formed. Furthermore, the axis between the I and Q channels of the frequency divider may be coincident with an axis between I and Q channels of a corresponding quadrature mixer.

In another aspect of the present invention, an apparatus may include an I channel to provide an I channel phase of a frequency divider and a Q channel to provide a Q channel phase. The I channel may have an I channel master storage element and an I channel slave storage element, and the Q channel may have a Q channel master storage element and a Q channel slave storage element. The I and Q channels may be at least substantially symmetric with respect to an axis therebetween.

In yet anther aspect, a system in accordance with one embodiment of the present invention may include a transceiver having a frequency divider with an I channel to provide an I channel phase and a Q channel to provide a Q channel phase, where the I and Q channels are at least substantially symmetric with respect to a center axis of the transceiver substrate. The transceiver may further include a quadrature mixer to receive the I and Q channel phases. The system, which may be a cellular telephone or other wireless device, may further include an antenna coupled to the transceiver to receive and transmit information and a processor coupled to the transceiver to process the information and control operation of the system.

### BRIEF DESCRIPTION OF THE DRAWINGS

FIG. 1A is a block diagram of a frequency divider in accordance with one embodiment of the present invention.

FIG. 1B is a signal flow diagram for the frequency divider of FIG. 1A.

FIG. 2 is a block diagram of a physical layout of a transceiver in accordance with an embodiment of the present invention.

FIG. 3 is a cross-sectional view of a latch device in accordance with one embodiment of the present invention.

FIG. 4 is a block diagram of a transceiver in accordance with another embodiment of the present invention.

FIG. 5 is a block diagram of a system in accordance with one embodiment of the present invention.

### DETAILED DESCRIPTION

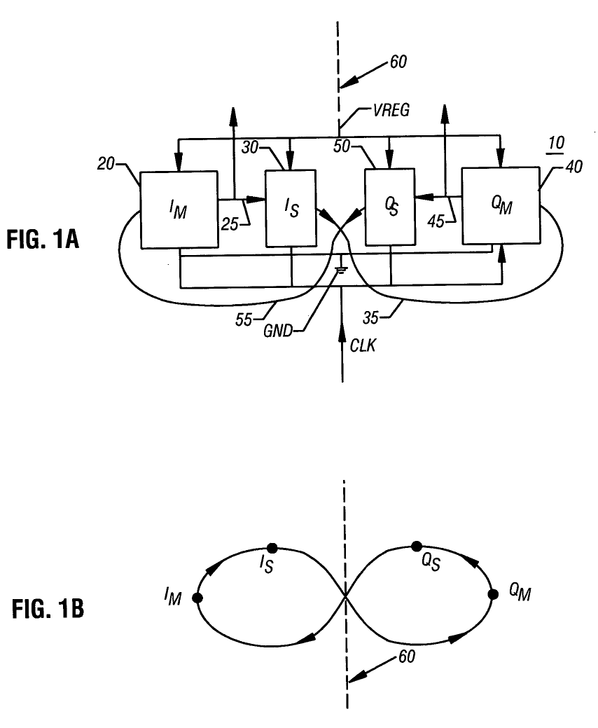

Referring to FIG. 1A, shown is a block diagram of a frequency divider in accordance with one embodiment of the present invention. As shown in FIG. 1A, frequency divider 10 may be a divide by four divider, although the scope of the present invention is not so limited. In the embodiment shown in FIG. 1A, frequency divider 10 may also provide a quadrature shift to the divided signals to generate quadrature outputs.

Frequency divider 10 may be used to receive an input frequency (i.e., CLK) and provide a divided version thereof to a mixer. More specifically, frequency divider 10 may be used to provide quadrature LO outputs to an associated quadrature mixer. While the frequency input into the divider may vary in different embodiments, in embodiments used in certain wireless applications, such as cellular telephones and the like, the clock may be between two and four times the divided frequency, although the scope of the present invention is not so limited.

Still referring to FIG. 1A, frequency divider 10 may be formed of a plurality of storage elements, such as latches, flip-flops, and the like. For example, in one embodiment, the storage elements may be D-type flip flops. Frequency divider 10 may include a master I channel storage element (I_{M}) 20 to which is coupled a slave I channel storage element (I_{S}) 30 via signal line 25. In turn, slave I channel storage element 30 may be coupled to a master Q channel storage element (Q_{M}) 40 (via signal line 35) which in turn, may be coupled to slave Q channel storage element (Q_{S}) 50 via signal line 45. As shown in FIG. 1A, an output from slave Q channel storage element 50 may be fed back to an input of master I channel storage element 20 via signal line 55.

Outputs from the two master storage elements may be coupled to respective inputs of a quadrature mixer via signal lines 25 and 45, respectively. However, in other embodiments, it is to be understood that outputs from the slave storage elements may be provided to the mixers instead.

As further shown in FIG. 1A, the I channel and Q channel portions of frequency divider 10 may be symmetric or substantially symmetric with respect to a center axis 60 of frequency divider 10. That is, as generally shown in FIG. 1A the various components of frequency divider 10 may be physically located such that corresponding components of each side are equal distances from center axis 60.

Further, as shown in FIG. 1A, the I and Q channels may be mirror images of each other. For example, as shown in FIG. 1A, the slave elements of each channel (i.e., I_{S} 30 and Q_{S} 50) may be located between center axis 60 and the master elements of the I and Q channels (i.e., I_{M} 20 and Q_{M} 40). Alternately, the master elements may be located between center axis 60 and the slave elements, in other embodiments.

In certain embodiments, center axis 60 may coincide with a center axis of the corresponding quadrature mixer. In such manner, routing of quadrature LO signals to the mixer may be inherently matched, affording better performance, including greater image rejection. The image rejection of frequency divider 10 (and more specifically the image rejection of a receiver including it) refers to the ability to reject responses resulting from RF signals at a frequency offset from the desired RF carrier frequency by an amount equal to twice the intermediate frequency (IF) of the receiver. In certain embodiments, positioning I and Q channels as set forth herein may lead to improved image rejection of approximately 10 db. More so, because components in frequency divider 10 are symmetric, voltage drops on the supply and ground traces (i.e., V_{REG} and GND) into each of the master and slave portions of the I and Q channels are matched, enhancing image rejection performance. As shown in FIG. 1A, the taps from the power supply rails may be on or substantially on center axis 60. Furthermore, RC delays of phase shifts in the clock traces (i.e., the CLK signal) provided to the I and Q channels may also be matched.

Also, in certain embodiments, frequency divider 10 may be physically located on an IC such that center axis 60 corresponds to a center axis of a substrate on which the IC is formed. Although shown in the embodiment of FIG. 1A as having a vertical alignment, in other embodiments symmetry of a frequency divider may be established with respect to a horizontal center axis. That is, frequency divider 10 may have a horizontal center axis coincident with a horizontal center axis of the IC device itself. In such manner, mechanical stresses may be balanced between the I and Q sides of frequency divider 10, enabling better matched performance and improved image rejection, even in the presence of such stresses. Furthermore, in such embodiments the corresponding quadrature mixer may also have its center axis coincident with the center axis of the chip.

In certain embodiments, parasitic coupling may exist between the different phases present in the I and Q channels. More specifically, parasitic capacitance may exist between master I channel storage element 20 and slave I channel storage element 30, resulting in phase errors. Similar parasitic capacitance and phase errors may also exist in the Q channel, namely between master Q channel storage element 40 and slave Q channel storage element 50, as well as between the I and Q channels. Accordingly, in certain embodiments, each of the storage elements may be physically located within a protective enclosure to prevent or at least reduce parasitic capacitance. While the formation of such protective enclosures will be discussed further below, as shown in FIG. 1A, such enclosures may take the form of boxes or isolation moats around the devices that form each of the stages of frequency divider 10, namely the master and slave portions of the I channel and Q channel. Conduits may form a protective shield around signal lines, such as those shown in FIG. 1A, that are routed to the devices within the protective enclosures to couple the devices forming frequency divider 10.

FIG. 1B is a signal flow diagram for frequency divider of FIG. 1A. More specifically, FIG. 1B shows that the signal flow between I and Q channels of the frequency divider may travel in a generally symmetric configuration with respect to center axis 60. In such manner, the signal flow through the frequency divider may be maintained symmetric with respect to the I and Q channels thereof.

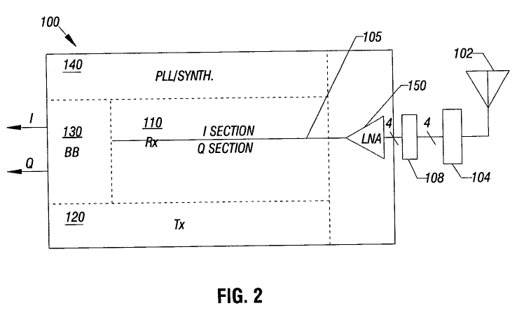

Referring now to FIG. 2, shown is a block diagram of a physical layout of a transceiver in accordance with one embodiment of the present invention. As shown in FIG. 2, transceiver 100 may include a receiver (Rx) portion 110, a transmitter (Tx) portion 120, a baseband (BB) portion 130, and a PLL/frequency synthesizer portion 140. FIG. 2 shows a physical layout of an example embodiment and is not intended to show specific components within a transceiver. Instead, FIG. 2 is intended to display a general physical chip layout that shows the location of receiver components, and more specifically local oscillator and mixer components, symmetric with respect to a center axis 105 of transceiver 100.

As shown in FIG. 2, incoming RF signals may be received by an antenna 102 and passed to an antenna switch 104. While different embodiments may be used with different RF communication devices, in one embodiment, incoming signals may be RF signals of a cellular telephone, and transceiver 100 may be a single chip transceiver for use in such a cell phone handset. Antenna switch 104 may be used to switch between incoming and outgoing signals from transceiver 100.

As shown in FIG. 2, one of a plurality of different bands may be input from antenna switch 104. Specifically, as shown in FIG. 2, a quad-band receiver may be present. For example, such a quad-band receiver may be adapted to receive Global System for Mobile Communications (GSM), Enhanced GSM (EGSM), Digital Cellular System (DCS), and Personal Communication System (PCS) signals, although the scope of the present invention is not so limited. In other embodiments, transceiver 100 may be used in a General Packet Radio Service (GPRS) device, a satellite tuner, or a wireless local area network (WLAN) device, for example.

Such incoming signals may pass through an external filter 108, such as a receive surface acoustic wave (SAW) filter bank, and be provided into transceiver 100, and more specifically to a low noise amplifier (LNA) 150. While shown as a single LNA, it is to be understood that multiple LNAs may be present to receive signals of the different bands. The output of LNA 150 may be provided to receiver section 110 which may include, for example, a quadrature mixer, as well as a frequency divider and other components used to generate a LO frequency.

As shown in FIG. 2, I section and Q section of receiver 110 may be symmetric with respect to center axis 105. In such manner, I and Q outputs that are suitably matched may be generated in receiver section 110 and provided to baseband section 130 for further processing and transmission to other devices within the system, such as digital components, e.g., a digital signal processor (DSP) and the like.

As further shown in FIG. 2, PLL/synthesizer 140 may be used to generate a reference frequency to be provided to both receiver section 110 and transmitter section 120 for use in mixing with incoming and outgoing RF signals. It is to be understood that the layout of FIG. 2 is exemplary, and different layouts may be developed in accordance with an embodiment of the present invention. Similarly, in some embodiments, at least portions of transmitter portion 120 may be positioned symmetrically to attain similar benefits in a transmission signal flow.

Thus in various embodiments, a transceiver may be fabricated having at least a frequency divider that is substantially symmetric with respect to its I and Q channels. Furthermore, the frequency divider may be formed such that the I and Q channels are mirrored with respect to each other. Such a transceiver may be fabricated in accordance with well-known semiconductor processing techniques, and may be fabricated with a complementary metal oxide semiconductor (CMOS) process, although the scope of the present invention is not so limited.

Furthermore, the transceiver may include a quadrature mixer having I and Q channels similarly adapted to be substantially symmetric and mirrored with respect to a center axis therebetween. Furthermore, in certain embodiments the quadrature mixer center axis and the center axis of the frequency divider may be substantially coincident with each other. Still further, in certain embodiments, both the center axis of the frequency divider and quadrature mixer may be substantially coincident with a center axis of a substrate on which they are formed. As used herein, a “substrate” refers to a single die that forms an individual integrated circuit, i.e., a transceiver. That is, during semiconductor processing, a semiconductor wafer, such as a 200 millimeter (mm) or 300 mm silicon wafer, may include a plurality of substrates, each of which when formed includes a complete integrated circuit.

As discussed above, in certain embodiments the devices that form the I and Q channels of a frequency divider may be located within a protective enclosure to prevent or reduce parasitic capacitance. Accordingly, during fabrication, a protective enclosure (e.g., a box) may be formed around each of the master and slave portions of the I and Q channels.

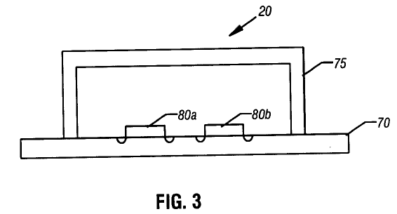

Referring now to FIG. 3, shown is a cross-section of a latch device in accordance with one embodiment of the present invention. As shown in FIG. 3, latch device 20 may correspond to master I channel storage element 20 of FIG. 1A. As shown in FIG. 3, latch device 20 may be formed on a substrate 70. Substrate 70 may have formed thereon a plurality of transistors 80a and 80b that form the latch. While shown for purposes of simplicity in FIG. 3 as including two transistors, it is to be understood that additional such devices and other components such as resistors and the like may be present within a storage element in accordance with an embodiment of the present invention. As further shown in FIG. 3, a protective enclosure 75, which may be a metal box, may be formed around latch device 20.

In an embodiment formed using a CMOS process technology, the devices that form each of the master and slave storage elements may be housed within a box or ring having a size of between approximately 5-15 microns (μm) width and 15-25 μm length. Furthermore, the thickness of the protective enclosure may be between approximately 0.5 μm and 2 μm. In one particular embodiment, the protective enclosure may form a box having dimensions of approximately 10 μm×20 μm×5 μm. While discussed with these example dimensions, it is to be understood that the scope of the present invention is not so limited. While the material of the enclosure may differ in some embodiments, the enclosure may be formed in a metal 6, 7, or 8 layer. During fabrication, conduits may be routed underneath and/or through a protective enclosure to couple devices therein to devices within a separate enclosure.

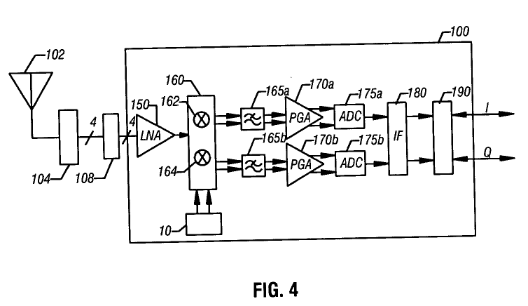

Referring now to FIG. 4, shown is block diagram of a transceiver in accordance with one embodiment of the present invention. As shown in FIG. 4, transceiver 100 may include components corresponding to the different portions of the physical layout of the transceiver shown in FIG. 2. As discussed above, such a transceiver may be a CMOS transceiver for quad-band GSM/GPRS wireless communications such as for use in cellular handsets and wireless data modems, although the scope of the present invention is not so limited.

As shown in FIG. 4, RF signals may be received via antenna 102 and passed through an antenna switch 104 and an external filter 108. The filtered incoming RF signals may then be provided to a LNA 150. From there, incoming RF signals may be provided to a quadrature mixer 160 having an I channel mixer 162 and a Q channel mixer 164. Quadrature mixer 160 may receive I and Q LO inputs from frequency divider and phase shifter 10, which may correspond to frequency divider 10 shown in FIG. 1A. While shown in FIG. 4 as being located at a bottom portion of transceiver 100, frequency divider 10 may be physically located coincident with a center axis of transceiver 100. In other embodiments, I and Q channels of frequency divider 10 may be symmetric with respect to each other, but not coincident with respect to a center axis of transceiver 100. In still other embodiments, a frequency divider may be symmetric with respect to a chip center axis but its I and Q controls may not be mirrored.

Still referring to FIG. 4, after quadrature mixer 160 downmixes the incoming RF signals to an intermediate frequency (IF), the I and Q channels may be routed to respective filters 165a and 165b and programmable gain amplifiers (PGA's) 170a and 170b. From there, the signals may be provided to analog-to-digital converters (ADC's) 175a and 175b for conversion to digital signals. The digital signals may then be provided to an IF block 180, for further downmixing and processing at a baseband frequency. Then the resulting baseband signals may be provided to an analog interface 190 for transmission to baseband components of a handset or other such device. While only the receive path is shown in FIG. 4, it is to be understood that similar components may be present within transceiver 100 to provide for reception of baseband signals from within the handset or other such device and conversion to RF signals for transmission via antenna 102.

While shown in FIG. 4 as including the particular components shown therein, it is to be understood that in other embodiments, transceiver 100 may include additional and/or different components, and the embodiment shown in FIG. 4 is for illustrative purposes.

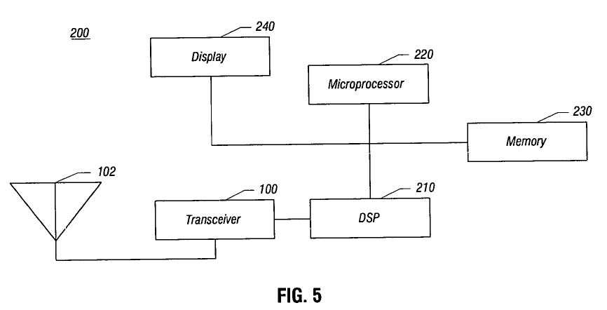

Referring now to FIG. 5, shown is a block diagram of a system in accordance with one embodiment of the present invention. As shown in FIG. 5, system 200 may be a cellular telephone handset, although the scope of the present invention is not so limited. For example, in other embodiments, the system may be a pager, personal digital assistant (PDA) or other such device. As shown, antenna 102 may be coupled to a transceiver 100, such as the transceiver shown in FIG. 4. In turn, transceiver 100 may be coupled to a digital signal processor (DSP) 210, which may handle processing of baseband communication signals. In turn, DSP 210 may be coupled to a microprocessor 220, such as a central processing unit (CPU) that may be used to control operation of system 200 and further handle processing of application programs, such as personal information management (PIM) programs, email programs, downloaded games, and the like. Microprocessor 200 and DSP 210 may also be coupled to a memory 230. Memory 230 may include different memory components, such as a flash memory and a read only memory (ROM), although the scope of the present invention is not so limited. Furthermore, as shown in FIG. 5, a display 240 may be present to provide display of information associated with telephone calls and application programs.

Although the description makes reference to specific components of system 200, it is contemplated that numerous modifications and variations of the described and illustrated embodiments may be possible. It is to be understood that transceiver 100 may include a frequency divider and quadrature mixer in accordance with an embodiment of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A frequency divider comprising:
an I channel to provide an I channel phase; and
a Q channel to provide a Q channel phase, wherein the I and Q channels are mirrored with respect to an axis therebetween.

2. The frequency divider of claim 1, wherein the I channel comprises a first portion and a second portion, wherein an output of the first portion comprises the I channel phase and an output of the second portion comprises an input to the Q channel.

3. The frequency divider of claim 2, wherein the Q channel comprises a first portion and a second portion, wherein an output of the first portion comprises the Q channel phase, and the output of the second portion comprises an input to the I channel.

4. The frequency divider of claim 3, wherein the second portions of the I and Q channels are located between the axis and the first portions of the I and Q channels.

5. The frequency divider of claim 2, wherein the first portion of the I channel comprises a master storage element and the second portion of the I channel comprises a slave storage element.

6. The frequency divider of claim 1, wherein the axis is substantially coincident with a center axis of an integrated circuit.

7. The frequency divider of claim 1, wherein an I channel signal path for the I channel phase and a Q channel signal path for the Q channel phase are matched.

8. The frequency divider of claim 1, wherein a clock input to the I channel and the Q channel comprises matched clock traces, and voltage drops in supply rails to the I channel and the Q channel are matched.

9. The frequency divider of claim 2, wherein the first portion of the I channel is located in a protective enclosure comprising a wall surrounding devices that form the first portion.

10. The frequency divider of claim 9, wherein the protective enclosure isolates the first portion from the second portion of the I channel.

11. An apparatus comprising:
an I channel of a frequency divider having an I channel master storage element and an I channel slave storage element, the I channel to provide an I channel phase; and
a Q channel of the frequency divider having a Q channel master storage element and a Q channel slave storage element, the Q channel to provide a Q channel phase, wherein the I channel and the Q channel are substantially symmetric with respect to an axis therebetween.

12. The apparatus of claim 11, wherein the slave storage elements of the I and Q channels are located between the axis and the master storage elements of the I and Q channels.

13. The apparatus of claim 11, wherein an output of the I channel master storage element comprises the I channel phase and an output of the I channel slave storage element comprises an input to the Q channel.

14. The apparatus of claim 11, wherein the axis is substantially coincident with a center axis of an integrated circuit.

15. The apparatus of claim 14, wherein the integrated circuit further comprises an I channel mixer to receive the I channel phase and a Q channel mixer to receive the Q channel phase.

16. The apparatus of claim 15, wherein the I channel mixer and the Q channel mixer have a center axis therebetween coincident with the axis between the I channel and the Q channel.

17. The apparatus of claim 11, wherein the master storage elements and the slave storage elements of the I and Q channels are each located in a protective enclosure comprising a wall surrounding devices that form, respectively, the master storage elements and the slave storage elements.

18. An apparatus comprising:
an I channel of a frequency divider to provide an I channel phase;
a Q channel of the frequency divider to provide a Q channel phase, wherein the I channel and the Q channel are substantially symmetric with respect to a center axis of a substrate supporting the frequency divider;
an I channel mixer to receive the I channel phase; and
a Q channel mixer to receive the Q channel phase.

19. The apparatus of claim 18, wherein the I channel and the Q channel of the frequency divider are mirrored with respect to the center axis.

20. The apparatus of claim 18, wherein the I channel mixer and the Q channel mixer have an axis of symmetry therebetween substantially coincident with the center axis.

21. The apparatus of claim 18, wherein the apparatus comprises a global system for mobile communications/general packet radio service transceiver.

22. A system comprising:
a transceiver having:
an I channel of a frequency divider to provide an I channel phase;
a Q channel of the frequency divider to provide a Q channel phase,
wherein the I channel and the Q channel are substantially symmetric with respect to a center axis of a substrate of the transceiver;
an I channel mixer to receive the I channel phase; and
a Q channel mixer to receive the Q channel phase;
an antenna coupled to the transceiver to receive and transmit information; and
a processor coupled to the transceiver.

23. The system of claim 22, wherein the I channel and the Q channel of the frequency divider are mirrored with respect to the center axis.

24. The system of claim 22, wherein the I channel mixer and the Q channel mixer have an axis of symmetry therebetween substantially coincident with the center axis.

25. The system of claim 22, wherein the transceiver comprises a global system for mobile communications/general packet radio service transceiver.

26. The system of claim 22, wherein the system comprises a cellular telephone.

27. A method comprising:
forming an I channel of a frequency divider on a substrate; and
forming a Q channel of the frequency divider on the substrate, wherein the I channel and the Q channel are substantially symmetric with respect to a center axis of the substrate.

28. The method of claim 27, wherein forming the I channel comprises forming a slave portion and a master portion, the slave portion disposed between the center axis and the master portion.

29. The method of claim 27, further comprising forming the Q channel as a mirror image of the I channel.

30. The method of claim 27, further comprising forming a quadrature mixer on the substrate, the quadrature mixer having a center axis substantially coincident with the center axis of the substrate.

31. The method of claim 28, further comprising forming a first protective enclosure around slave devices forming the slave portion and forming a second protective enclosure around master devices forming the master portion.

32. The method of claim 31, wherein the first and second protective enclosures each comprise an isolation moat surrounding the slave portion and the master portion, respectively.

33. The method of claim 31, further comprising forming at least one conduit to couple the slave portion and the master portion through the first protective enclosure and the second protective enclosure.
